(19) United States
(12) Patent Application Publication
(10) Pub. No.: US 2025/0357797 A1
(43) Pub. Date: Nov. 20, 2025

(54) A WIRELESS POWER SYSTEM FOR USE IN AN AREA HAVING VARIED LEVELS OF HUMAN PRESENCE

(71) Applicant: Wi-Charge Ltd., Rehovot (IL)

(72) Inventors: Yochai Dan, Azrikam (IL); Victor Vaisleib, Ramat Hasharon (IL); Ori Refael Mor, Tel Aviv (IL); Nir Simon, Kibbutz Ein Hashofet (IL); Aline Illouz, Ashdod (IL); Lilach Stein, Rehovot (IL); Gregory Heifetz, Rehovot (IL); Pavel Berman, Ness Ziona (IL); Eli Zlatkin, Tel Aviv (IL); Ortal Alpert, Ness Ziona (IL)

(73) Assignee: Wi-Charge Ltd., Rehovot (IL)

(21) Appl. No.: 19/130,444

(22) PCT Filed: Nov. 15, 2023
(86) PCT No.: PCT/IL2023/051185

§ 371 Date: May 15, 2025

(30) Foreign Application Priority Data
Nov. 15, 2022 (IL) 298271

(51) Int. Cl. H02J 50/60; H02J 50/30

(52) U.S. Cl. CPC H02J 50/60; H02J 50/30

(57) ABSTRACT

New systems for ensuring the reliable function of systems for laser powering and information propagation using receivers located in premises frequented by the public, such as a store or a public office, using information displays. The systems employ a wireless power transmitter which has a detector for determining whether the premises is operating in a situation characteristic of normal working hours, with people present who may interfere with its correct operation, or whether the situation is typical of closed premises, with low or zero occupancy, enabling the system to operate reliably in what may be termed an “after-hours” mode. Operations which must be performed reliably include charging the receivers, updating of the displays, maintenance of the devices, and software updates. The system can detect the presence of human activity directly, or by implication by the cessation of services such as lighting or air conditioning in the area.

### FIELD OF THE INVENTION

The present disclosure describes laser technology related to the field of remote information display and interchange within areas having public access, especially as applied to commercial information display in sales areas and shops where public access may interfere with the transmission of the information and generally as applied to the field of wireless power transmission using lasers.

### BACKGROUND

Commercial environments, such as stores and other public buildings may greatly benefit from being able to easily deploy large amounts of electronic information or sales assisting devices in their premises, such as display screens, electronic shelf labels, various sensors, digital cameras and the like. Such systems are able to display digital contents to customers, collect valuable data and provide higher revenues and lower cost of ownership to the property. Display screens may present information, such as information about products, whether relating to price or content, such as nutritional value for example, advertising, warnings, and current information, such as the existence and time limits of discounts on the product, while sensors may sense human presence, temperatures, and electronic signals.

Location awareness is used on many existing screen, sensor or camera devices, such as smartphones, and such devices are able to transmit their location and may also show dynamic content based on location. Wireless laser tags are another remote information providing system, which provide remote tracking, such as is shown in U.S. Pat. No. 7,229,017 for “Laser Locating and Tracking System for Externally Activated Tags” to E. A. Richley et al, and US Published Patent Application No. 2015/0022321 for “Long-Range Electronic Identification System” to D. K. Lefevre.

There is significant monetary value for operators of such locations in devices such as information screens, sensors, cameras, and similar devices, that enable automatic location and information exchange in public places.

In patent application No. IL 289682, for “Laser Triggered Display Device”, commonly owned and having a common inventor with the present applicant, there is described a system using fluorescence detection by the laser beam, or another form of detection, to ensure reliable communication and control of the deployed devices in a public place. However, when such an information transmission system uses a laser beam to convey the information from the base station to the display units deployed in the area, the systems are limited because of the presence of people or their shopping trolleys in the region. Thus, lack of functionality can arise when the number of persons who may intercept the laser beam, prevent the transfer of the relevant information. Additionally, the update of information or the maintenance of the display devices may be affected by the presence of people continually crossing the laser beam path.

The disclosures of each of the publications mentioned in this section and in other sections of the specification, are hereby incorporated by reference, each in its entirety.

### SUMMARY

The present disclosure attempts to provide novel systems and methods that overcome at least some of the disadvantages of prior art systems and methods. The present disclosure describes new exemplary systems for ensuring the reliable function of a system for laser powering and information propagation in an area where such actions are required. It is to be emphasized that the term “area” as used in this disclosure, and as thuswise claimed, relates to regions of a three dimensional space in which the systems are installed, and is intended to relate not only to the “floor space” area, but also to the usable height of that area. Some such systems are described in the above referenced patent application IL289682, for the updating of display devices in premises frequented by the public, such as a store or a public office using information displays. The systems employ a wireless power transmitter which has a detector for determining whether the premises where the system is installed is operating in a situation characteristic of normal working hours, with the presence of people who may interfere with its correct operation, or whether the situation is that typical of when the premises are closed, with low or zero occupancy, enabling the system to operate reliably in what may be termed an “after-hours” mode. This allows for optimizations of the operation, but requires certain adaptations to the device to allow such operation. The type of operation which must be performed reliably includes the charging of energy storage devices in the displays within the area of installation of the system, updating of the displays, the routine maintenance of the devices, and the software update when necessary.

In what may be considered a common situation, since the lighting may be turned off once the premises close, after hours operation can be detected by a simple light sensor. Alternatively, the system may tap into one of the IT data storage modules, or into the infrastructure control of the facility from which information about the occupancy can be obtained, such as information from the computer system, the power supply to the lighting system, or to an alarm system, or to the air conditioning system.

In the after-hours mode, the device typically has less beam blocking events and hence may be configured differently. Specifically, in after-hours mode, the surroundings change rather slowly, so when the line of sight between a transmitter and a receiver on a display device is blocked, it is expected to remain blocked for a longer period of time than in “normal working hours”, and when it is clear, it is expected to remain clear, and enable proper communication in the link, for a long period of time, such as overnight, or over the length of the weekend.

One of the advantageous features of the systems of the present disclosure is the use of an energy storage device, such as a rechargeable battery or a super-capacitor in the transmitter, such that the transmitter can continue operation even when the external supply of electricity is absent. This feature is useful for systems which rely on the power supply to the lighting system for their operation, which is terminated during the after-hours period where the lighting is no longer necessary. Since that is the period when the transmitter can communicate most reliably with the display receiver devices, it is important that power be available for operation after-hours, and this can be supplied by the charged battery or super-capacitor.

The tasks which the system can perform more efficiently and more safely in the after-hours mode without disturbance form persons obstructing the communication between the base station and the deployed device can include powering the transmitter from the rechargeable battery or supercapacitor, powering or recharging remotely located receiver devices, updating the data for display on the receiver devices, performing routine maintenance or calibration procedures on the remote receiver devices or on the transmitter, updating firmware or software on the remote receiver devices, or on the transmitter, and others.

The described implementation of recharging remotely located receiver devices is particularly advantageous, since it enables the avoidance of transmitting a power recharging beam during times when there may be significant human presence in the area, and does enable transmitting a power recharging beam during times when there should be negligible or no human presence in the area, even when there is no power supply to power the transmitter, since the power has been cut off “after hours” with the cessation of need for power in the area, and the transmitter then continuing operating using the transmitter rechargeable battery.

There is thus provided in accordance with an exemplary implementation of the systems described in this disclosure, a system for wireless power transmission into an area, the area having either a first or a second characteristic situation, requiring respectively a first or a second mode of operation of the system, the system comprising:

(i) a safety system for ensuring safe transmission of the wireless power in the area, and

(ii) at least one transmitter adapted to transmit the wireless power to at least one receiver, the at least one transmitter comprising,
(a) a wireless power emitter adapted to transmit a power beam of the wireless power to the at least one receiver,
(b) a beam directing unit adapted to accurately direct the power beam towards the at least one receiver,
(c) a power supply powered from an external supply of electricity,
(d) a rechargeable battery, adapted to be recharged from the power supply,
(e) a detector for monitoring the characteristic situation of the area specific to enable either the first or the second mode of operation of the system, and
(f) a microprocessor adapted to control operation of the system,

wherein, upon receiving a signal from the detector indicating a change of the area from the first characteristic situation to the second characteristic situation, the system is enabled to perform at least two of the following actions:

(iii) transmit a wireless power beam to at least one receiver,

(iv) power the transmitter from the rechargeable battery,

(v) perform routine maintenance tasks of the wireless power transmission system,

(vi) update software and firmware of the microprocessor of the wireless power transmission system,

(vii) update data provided to at least one of the receivers,

(viii) perform self-testing of the wireless power transmission system, and

(ix) perform calibration tests on the safety system.

In such a system, the characteristic situation of the area monitored by the detector may be at least one of:

(a) an indication of a predetermined level of human activity within the area,

(b) a level of light in the area,

(c) a status of the power supply to the lighting system,

(d) a status of an intrusion alarm system installed in the area,

(e) a status of the air conditioning system installed in the area, or

(f) an indication from a predetermined lighting schedule that the lighting is terminated or reduced at the current time.

The above-described area in which the above mentioned systems may be used, can be an enterprise for conducting sales of goods, and the characteristic situation of the area is selected to indicate whether the enterprise is open to the public or closed to the public. Additionally, the detector may be adapted to determine the sign of human activity in the area even if the humans are outside an effective transmission range of the system.

In the above described systems, indication of human activity within the area may be determined either from a direct measure of the human activity within the area, or from an indication of a situation in the area generated to enable a level of human activity within the area.

Additionally, the external supply of electricity may be provided from a lighting circuit in the area, such that if the lighting in the area is turned off during the time when the system is switched to the second mode of operation, the functions of the system can still be performed using the transmitter rechargeable battery as the power source of the system.

Furthermore, in any of those systems, the level of light in the area may be predetermined to provide light for the human activity.

In the transmitter, the wireless power emitter may be a laser, and the power beam a laser beam. Additionally, the beam directing unit may comprise a directionally controlled mirror.

According to yet another implementation of the systems described in this disclosure, there is further provided a system for wireless power transmission into an area having different levels of human activity, the system comprising:

(i) a safety system for ensuring safe transmission of the wireless power in the area, and

(ii) at least one transmitter adapted to transmit the wireless power to at least one receiver, the at least one transmitter comprising,
(a) a wireless power emitter adapted to transmit a power beam of the wireless power to the at least one receiver,
(b) a beam directing unit adapted to accurately direct the power beam towards the at least one receiver,
(c) a power supply powered from an external supply of electricity,
(d) a transmitter rechargeable battery, adapted to be recharged from the power supply,
(e) a detector for monitoring a characteristic situation related to the level of human activity in the area, and
(f) a microprocessor adapted to control operation of the system,

wherein, upon receiving a signal from the detector indicating that the characteristic situation of the area has changed to one indicating with a high likelihood that that the human level of activity has fallen below a predetermined level, the system is enabled to perform at least two of the following actions:

(iii) transmit a wireless power beam to at least one receiver,

(iv) power the transmitter from the transmitter rechargeable battery,

(v) perform routine maintenance tasks of the wireless power transmission system,

(vi) update software and firmware of the microprocessor of the wireless power transmission system,

(vii) update data provided to at least one of the receivers,

(viii) perform self-testing of the wireless power transmission system, and

(ix) perform calibration tests on the safety system.

In such a system, the characteristic situation monitored by the detector and related to the level of human activity in the area, may be at least one of:

(a) a level of light in the area,

(b) a status of the power supply to the lighting system,

(c) a status of an intrusion alarm system installed in the area,

(d) a status of the air conditioning system installed in the area, or

(e) an indication from a predetermined lighting schedule that the lighting is terminated or reduced at the current time.

Furthermore, at least one receiver may have a rechargeable battery, which can be charged by the transmitted wireless power beam.

In any of those systems, the wireless power emitter may be a laser, and the power beam a laser beam.

### BRIEF DESCRIPTION OF THE DRAWINGS

The present invention will be understood and appreciated more fully from the following detailed description, taken in conjunction with the drawings in which:

FIG. 1 illustrates schematically the typical appearance of an area of an exemplary commercial environment, in this case the display aisle of a store, showing many electronic devices installed at suitable positions on the shelves, with which a laser transmission system has to communicate, the view being shown during regular working hours, with a number of people circulating;

FIG. 2 shows schematically, the same area as that of FIG. 1, but after regular working hours, without any disturbance from shoppers, thus providing visual access to the display devices; and

FIG. 3 is a block diagram showing schematically the elements of an exemplary wireless power transmitter of the presently described systems.

### DETAILED DESCRIPTION

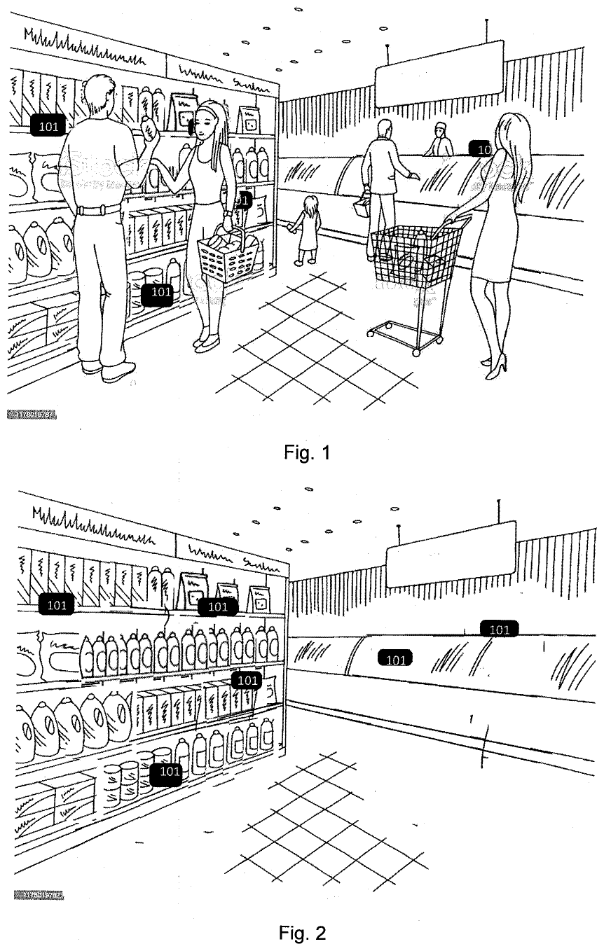

Reference is first made to FIG. 1, which illustrates pictorially an area of an exemplary commercial environment, in this case the display aisle of a store, during regular working hours. The view is that obtained from the position of the transmission unit. In the setting of FIG. 1, there are shown many electronic devices 101 installed at suitable positions on the shelves. The operation of such devices, and their function, may be like those described in the above-mentioned patent application IL289682. Such devices may include a display screen, location sensors, temperature sensors, imaging or inspecting apparatus enabling the determination of the number of products still present on the shelf, or a view of, or estimation of the number of purchasers in the vicinity of the device, or any other function which such an intelligent device can be called upon to perform in such a setting. For simplicity's sake, throughout the rest of the disclosure, such devices 101 will be referred to as ‘receivers’.

Receivers 101 may be powered and supplied with information or operational instructions, by a transmitter, which may advantageously use a collimated laser beam (not shown in FIG. 1) to transfer power to the receiver. Such a transmission device is often mounted on the ceiling, from where it will have an optimal view of the area being surveilled, though any other suitable mounting position may be used. Other modes of addressing and communicating with the receivers are also known in the art, and the present application is not intended to be limited to the methods described in IL 289682. During regular working hours, some of the receivers 101 may be periodically blocked from the transmitter's view due to obstructions, such as people or shopping carts, as depicted in FIG. 1. This view blockage may completely prevent the execution of the task, or in some cases, even worse, by enabling the task to commence, but to interrupt it in mid-execution, a situation whose result could range from simple inability to perform the task, to a dangerous situation. The latter situation could result, for instance, where the task is wrongly recorded as having been achieved, when in practice, the recorded result is incorrect because the task was interrupted in the middle. As a result, certain operations relating to the functions or maintenance of the receivers may be difficult to carry out during regular working hours.

For example, the following non-limiting list of operations may be difficult to complete, impossible to complete, or may even be unsafe to conduct during normal working hours, whilst people may be in the vicinity of the system:
Mapping receivers in the commercial area.
Periodic reboot-in order to bypass various common programming errors and bugs by clearing memory and performing tests, many devices restart every few hours, during such a restart the power supply to the devices may be off, and hence, it would be better to perform periodic reboots during the “after hours” period.
Transmitter software update-typically done safely by turning the laser off before the update and turning the laser on again after the update.
Receiver software update.
Powering the transmitter from an alternative power source, since the external power source, often wired electrical power from the building's infrastructure, may not be live other than during normal working hours.
Adapt cooling temperature stabilization of the transmitter to “air-conditioning off” settings. Whereas during normal working hours, the ambient temperature in the commercial area is usually regulated to somewhere in the range 15° C.-30° C., after-hours, the ambient temperature may drift to a temperature of between −10° C. and 60° C., depending on the external climate conditions where the commercial area is located, and the parts of the commercial area exposure thereto. This may require the device itself to operate an internal cooling or heating system to maintain acceptable operating temperatures for internal components of the transmitter.
Changing power levels, as higher power levels may be allowed at after-hours times, when no people are circulating in the area.
Changing the power schedule, such as by spending a longer or shorter time on each receiver.
Self-test-also an operation that is better done in “after hours mode”
Maintenance tasks
Room mapping
Report home
Parameter update
Calibration
Prioritization change-different clients sometimes require different power schemes during after-hours mode, for example, alarm sensors may need power during after-hours, while advertising screens and sensors may not.

In order to overcome this problem, the systems of the present disclosure are configured to attempt to avoid performing tasks which may be disturbed or unreliable when there is a high likelihood of obstructions, as in the situation of FIG. 1. Such tasks are more preferably enabled when the environment is essentially or completely clear of intrusions, such as in the exemplary scenario shown in FIG. 2, which shows the scenario of FIG. 1 but after the regular hours of activity in the store. As can be seen from FIG. 2, receivers 101 are now clear of any obstructions and therefore, the transmitter can have an uninterrupted connection with receivers 101.

The simplest way of achieving the aim of avoiding interference by shoppers and their shopping trolleys is by limiting the performance of the problematic tasks to specific hours when the store is closed. In the present disclosure, this manner of operation is known as an “after hours” mode, and its content and operation will be expounded hereinbelow. In US published patent application US 2014/0292269, for “Wireless Power Charging Timing and Charging Control” to Qualcomm Inc., there is described a near-field RF wireless charging system that is programmed with user schedules of times when charging is allowed, based on a number of alternative considerations, such as energy rates, or work or school schedules, when there should be no or less interference by persons in the space. In contrast to the systems of that reference, a novel aspect of the method of operation of the systems described in the present application is envisaged where the critical tasks can be performed, not during specific preprogrammed times, but based on real-time observations of the extent of activity occurring, and programming the system to perform these tasks only in after hours times, when activity is actively detected as being below a predetermined level at which the tasks can be satisfactorily performed. This latter enabling period, which is essential for establishments open around the clock, is also considered to fall within the definition of an “after hours mode”, even though it may still be within opening hours. As an additional or alternative scenario, the task could be enabled by associating the enablement of the task with a detected environmental situation, such as the presence or lack of lighting, or air conditioning, or other provided services to the area, with the understanding that these situations are activated according to the extent of activity occurring. Thus, for instance, the detection of a lack of lighting in the area would be associated with the lack of a need for lighting after normal opening hours.

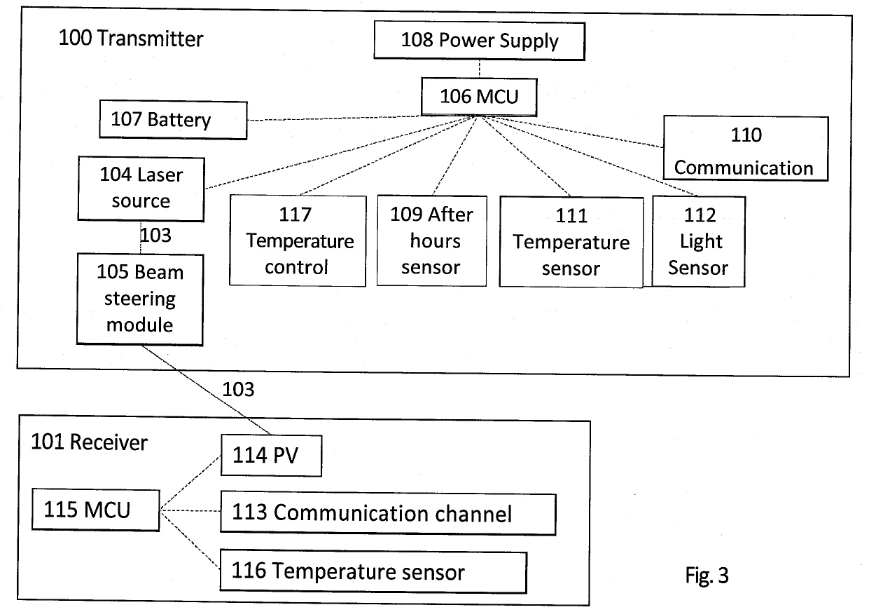

Reference is now made to FIG. 3, which is a block diagram showing schematically the elements of an exemplary wireless power transmitter of the presently described systems.

Transmitter 100 transmits power and/or supplies information/operation instructions to receiver 101.

Transmitter 100 comprises a microcontroller (MCU) 106 and an “after-hours” sensor 109, the after-hours sensor 109 allowing the MCU 106 to determine whether the system is currently in its “normal operation mode” or in its “after hours mode”. The method by which sensor 109 operates is described hereinbelow.

During normal operation mode, the MCU 106 causes laser source 104 to emit a laser beam 103 and beam steering module 105 to direct laser beam 103 accurately towards the photovoltaic cell (PV) 114 of receiver 101. The term “accurately” is understood to mean that the beam steering module is accurate enough, and the laser beam is sufficiently well collimated that the beam impinges on the photovoltaic cell of the receiver without causing excessive beam power incidence other than into the PV cell. The MCU 106 may also cause the beam steering module 105 to direct laser beam 103 in different scanning directions in the surrounding area, in order to probe those areas for obstructions or for receivers 101.

During the normal operation mode, the MCU 106 receives power from power supply 108, which is usually fed from the mains power supply. In order to provide the best non-obstructed view of the relevant area of the commercial environment, the transmitter 100 may be mounted from the ceiling. This therefore requires provision of a mains supply point next to each intended transmitter location. Since the provision of separate dedicated mains supply points in the ceiling is a costly procedure, and especially for a newly installed system in an already existing building, the mains power to the transmitters 100 and their internal power supplies 108 may be most conveniently provided by connection to the power feed to an existing lighting system of the setting, or to any other suitable ceiling located infrastructure that is in operation within the setting, such as power supply lines to air conditioning systems. This results in significantly lower installation costs, since no separate mains power supply needs to be installed for the wireless transmission system, and connection to the lighting system is usually facile. For temporary measures, or for low-cost situations, it is even possible to attach the system to a lamp socket.

However, as explained previously, many maintenance and updating operations of the system cannot take place during regular hours in the normal operation mode, and can only be done safely and efficiently when the system is operating in the after-hours mode. If the power supply is sourced from the existing lighting infrastructure, or another suitable framework, such as the air conditioning system, which may operate only when the commercial area is in use, a problem arises in that during the after-hours period, when the essential transmission system care and maintenance should be performed, the lights will also be operated in an ‘after-hours’ mode, meaning that they are either switched off entirely, or left on in a spatially diluted mode, thus essentially cutting off the power to the transmitters 100 exactly during the period when they need to be in use.

In order to overcome this problem, the transmitter 100 may also include a battery 107, and the MCU 106 is programmed to instruct the charging of the battery 107 during the daytime work-hours, using power from the power supply 108, which is connected to a nearby power line (not shown in FIG. 3). Therefore, even if there is a cessation of power to power supply 108 by the turning off of the lighting circuits or the air conditioning circuits in the after-hours period, the transmission system can continue operating without interruption by utilizing power from the battery 107, ensuring safe running of all operations, without limiting the system to being dependent on a continuously available mains power source.

During normal operation mode MCU 106 probes after-hours sensor 109. If the after-hours sensor 109, detects an event indicative of the ‘after hours’ status, the MCU 106 causes the system to switch to the ‘after hours mode’.

The ‘after-hours’ sensor 109 is configured to detect when the environment is considered as being in an ‘after-hours’ status. This may be identified by either a motion sensor, or a camera system, or a light sensor or by tapping into the IT base or into the infrastructure of the facility, such as the computer system, an alarm system, the lighting system or a data network, such as an internal communication system or the internet. The lighting system can be monitored either by detecting the actual lighting conditions, or the power in the lighting supply leads.

There are a number of methods by which the after-hours sensor can detect that the system should switch to an after-hours mode:
1. Using a command or external signal, such as actuation by a person leaving and locking-up the area
2. Using a clock or schedule.
3. Connection to a sensor, such as a camera system for detecting the presence of people.
4. Connection to a light sensor or temperature sensor.
5. Connection to the intrusion alarm system.
6. Sensing the power to the lighting system.

Some of these methods, such as methods 3 and 4 above, are dependent on sensing the surroundings to determine when the after-hours mode can be initiated, and others are based on automatic operation by predetermined programming from other sources.

When the system is in its ‘after-hours’ mode, there are typically less beam blocking events and hence the transmitter and receiver may be configured differently from the normal working hours configuration. Specifically, during the period of time that is defined as ‘after-hours’, the surroundings change slowly, if at all, and therefore, when the line of sight between a transmitter and a receiver is blocked, it is expected to remain blocked for a longer period of time as opposed to “normal working hours”.

It is easier to scan the environment to get a clear picture of where fixed receivers are installed during the ‘after-hours’ mode, than during “working hours” where many of the receivers may be temporarily hidden behind moving people and objects.

During ‘after-hours’ mode, the MCU 106 may use a communication system 110 to receive software updates for either transmitter 100 or receiver 101.

The MCU 106 may initiate self-test procedures, for example, adjusting laser 104 to different power levels, changing the settings of the beam steering module 105 or of any of the other components of the transmitter 100.

The MCU 106 may also cause itself to reboot, which, for safety reasons, should only be performed while the laser is off, or it may initiate procedures for calibration of the laser source 104 or the sensors in the system, such as sensor 109.

An additional need for the use of the systems of the present application arises from the situation when the communication network may be inoperative, or may be not be free. The communication network, such as a Wi-Fi network, may on the one hand be turned off during after-hours, which would be a problem for receiving software update, though not for installing them if already downloaded. On the other hand, the network (“WiFi”) during normal hours may be “traffic jammed”, or may be blocked by interference from other radio sources. Therefore, it may be easier to use the network, if it is not turned off, during after-hours, than during the work hours.

Finally, the required service levels may be different between the normal work hours, and in after-hours. It may be acceptable if service stops for a short while in the after-hours mode, but unacceptable if the same problem were to apply during operating working hours. Thus, for example, it would be acceptable, or even advisable for energy saving measures, if an advertisement screen were off during after-hours, and on during shopping hours. Likewise, it would be acceptable if a temperature sensor did not operate for an hour or two during “after-hours”, whereas during normal working hours, a non-reporting sensor may be a major problem.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. Furthermore, it is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for wireless power transmission into an area, the area having either a first or a second characteristic situation, requiring respectively a first or a second mode of operation of the system, the system comprising:
a safety system for ensuring safe transmission of the wireless power in the area; and
at least one transmitter adapted to transmit the wireless power to at least one receiver, the at least one transmitter comprising;
a wireless power emitter adapted to transmit a power beam of the wireless power to the at least one receiver;
a beam directing unit adapted to accurately direct the power beam towards the at least one receiver;
a power supply powered from an external supply of electricity;
a rechargeable battery, adapted to be recharged from the power supply;
a detector for monitoring the characteristic situation of the area specific to enable either the first or the second mode of operation of the system; and
a microprocessor adapted to control operation of the system;
wherein, upon receiving a signal from the detector indicating a change of the area from the first characteristic situation to the second characteristic situation, the system is enabled to perform at least two of the following actions:
(i) transmit a wireless power beam to at least one receiver;
(ii) power the transmitter from the rechargeable battery;
(iii) perform routine maintenance tasks of the wireless power transmission system;
(iv) update software and firmware of the microprocessor of the wireless power transmission system;
(v) update data provided to at least one of the receivers;
(v) perform self-testing of the wireless power transmission system; and
(vi) perform calibration tests on the safety system.

2. A system according to claim 1, wherein the characteristic situation of the area monitored by the detector is at least one of:
(a) an indication of a predetermined level of human activity within the area;
(b) a level of light in the area;
(c) a status of the power supply to the lighting system;
(d) a status of an intrusion alarm system installed in the area;
(e) a status of the air conditioning system installed in the area; or
(f) an indication from a predetermined lighting schedule that the lighting is terminated or reduced at the current time.

3. A system according to either of the previous claim, wherein the area is an enterprise for conducting sales of goods, and the characteristic situation of the area is selected to indicate whether the enterprise is open to the public or closed to the public

4. A system according to any of the previous claim, wherein the detector is adapted to determine the sign of human activity in the area even if the humans are outside an effective transmission range of the system.

5. A system according to any of the previous claims, wherein the indication of human activity within the area is determined either from a direct measure of the human activity within the area, or from an indication of a situation in the area generated to enable a level of human activity within the area.

6. A system according to any of the previous claims, wherein the external supply of electricity is provided from a lighting circuit in the area, such that if the lighting in the area is turned off during the time when the system is switched to the second mode of operation, the functions of the system can still be performed using the transmitter rechargeable battery as the power source of the system.

7. A system according to any of the previous claims, wherein the level of light in the area is predetermined to provide light for the human activity.

8. A system according to any of the previous claims, wherein the wireless power emitter is a laser, and the power beam is a laser beam.

9. A system according to claim 8, wherein the beam directing unit comprises a directionally controlled mirror.

10. A system for wireless power transmission into an area having different levels of human activity, the system comprising:
a safety system for ensuring safe transmission of the wireless power in the area; and
at least one transmitter adapted to transmit the wireless power to at least one receiver;
the at least one transmitter comprising;
a wireless power emitter adapted to transmit a power beam of the wireless power to the at least one receiver;
a beam directing unit adapted to accurately direct the power beam towards the at least one receiver;
a power supply powered from an external supply of electricity;
a transmitter rechargeable battery, adapted to be recharged from the power supply;
a detector for monitoring a characteristic situation related to the level of human activity in the area; and
a microprocessor adapted to control operation of the system;
wherein, upon receiving a signal from the detector indicating that the characteristic situation of the area has changed to one indicating with a high likelihood that the human level of activity has fallen below a predetermined level, the system is enabled to perform at least two of the following actions:
(i) transmit a wireless power beam to at least one receiver;
(ii) power the transmitter from the transmitter rechargeable battery;
(iii) perform routine maintenance tasks of the wireless power transmission system;
(iv) update software and firmware of the microprocessor of the wireless power transmission system;
(v) update data provided to at least one of the receivers;
(v) perform self-testing of the wireless power transmission system; and
(vi) perform calibration tests on the safety system.

11. A system according to claim 10, wherein the characteristic situation monitored by the detector, and related to the level of human activity in the area, is at least one of:
(a) a level of light in the area;
(b) a status of the power supply to the lighting system;
(c) a status of an intrusion alarm system installed in the area;
(d) a status of the air conditioning system installed in the area; or
(e) an indication from a predetermined lighting schedule that the lighting is terminated or reduced at the current time.

12. A system according to either of claims 10 and 11, wherein at least one receiver has a rechargeable battery, which can be charged by the transmitted wireless power beam.

13. A system according to any of claims 10 to 12, wherein the wireless power emitter is a laser, and the power beam is a laser beam.
